(19) United States
(12) Patent Application Publication
(10) Pub. No.: US 2016/0321678 A1
(43) Pub. Date: Nov. 3, 2016

(54) CUSTOMER LIFECYCLE PREDICTION

(71) Applicant: Linkedln Corporation, Mountain View, CA (US)

(72) Inventor: Jimmy Wong, San Mateo, CA (US)

(21) Appl. No.: 14/700,429

(22) Filed: Apr. 30, 2015

(51) Int. Cl. G06Q 30/02

(52) U.S. Cl. CPC G06Q 30/0201; G06Q 50/01

(57) ABSTRACT

Techniques for assessing a relationship between two companies are provided. The relationship may be a customer-vendor relationship. Social connections between certain employees at one company and certain employees at another company are compared to determine whether one company is a customer of the other company. For example, if one or more employees with a particular job function/role at a first company are connected to one or more employees with a particular job function/role at a second company, then such connections may be indicative that the two companies are not in a customer-vendor relationship, are in a stage of forming in a customer-vendor relationship, or are in a customer-vendor relationship.

### TECHNICAL FIELD

The present disclosure relates to data processing and, more particularly, to assessing relationships between companies based on social network data.

### BACKGROUND

A critical function of a business is to sell its products or services to customers. The number of customers a business has (“customer base”) corresponds to how successful the business is. Word of mouth is one (passive) way for a business to expand its customer base. Advertising is another more common (active) way for a business to expand its customer base.

Advertising may take many forms. Some advertising, such as ads on buses or on billboards, target the general public, while other ads target a specific segment of potential customers, such as business executives, pet owners, or users of a particular software application.

Advertising can be a significant expense for any business. Therefore, if a business can identify and target the right potential customers, then the more successful the business is likely to be. One way to identify potential customers is through “market research,” which is an organized effort to gather information about target markets or customers. Thus, market research is an important component of business strategy and is a key factor in maintaining competitiveness over competitors. Market research provides important information to identify and analyze the market need, market size, and competition. Market research may be performed “in-house” (i.e., by the business that is attempting to identify potential customers) or by a third party that may specialize in performing market research for businesses in one or more industries.

Current methods for performing market research involve asking each customer (or potential customer) directly through interviews or surveys about the level of customer-vendor relationship they have with one or more vendors. Such methods are thus subject to human error and require significant human intervention, resulting in relatively high labor costs.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for assessing relationships among companies, in an embodiment;

FIG. 2 (consisting of FIGS. 2A and 2B) is a flow diagram that depicts a process for assessing a relationship between two companies, in an embodiment;

FIG. 3 is a block diagram that depicts a process for generating, training, and using a model for determining a likelihood that one company is a customer of another company, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Relationships (or potential relationships) between companies are assessed based on online activities, such as social network connections. In one technique, one or more connections between social network members who indicate that they work for two different companies are identified to determine a likelihood of one company being a customer of the other company. If there is a connection between users with certain roles at the respective companies, then an assessment of the relationship between the two companies is made. For example, it may be determined that the two companies are in a pre-sales relationship or have established a vendor-customer relationship. With such information about a first vendor and a potential customer, a second vendor may determine whether to spend time and resources attempting to persuade the potential customer to be an actual customer of the second vendor.

While embodiments are described herein with respect to companies, the relationship between any type of organization or entity may be assessed, regardless of the size of the entity (e.g., a single person or a world-wide charitable organization), the type of entity (e.g., a sole proprietor, partnership, corporation, government), or the nature of the business of the entity (e.g., educational, for-profit, non-profit).

### System Overview

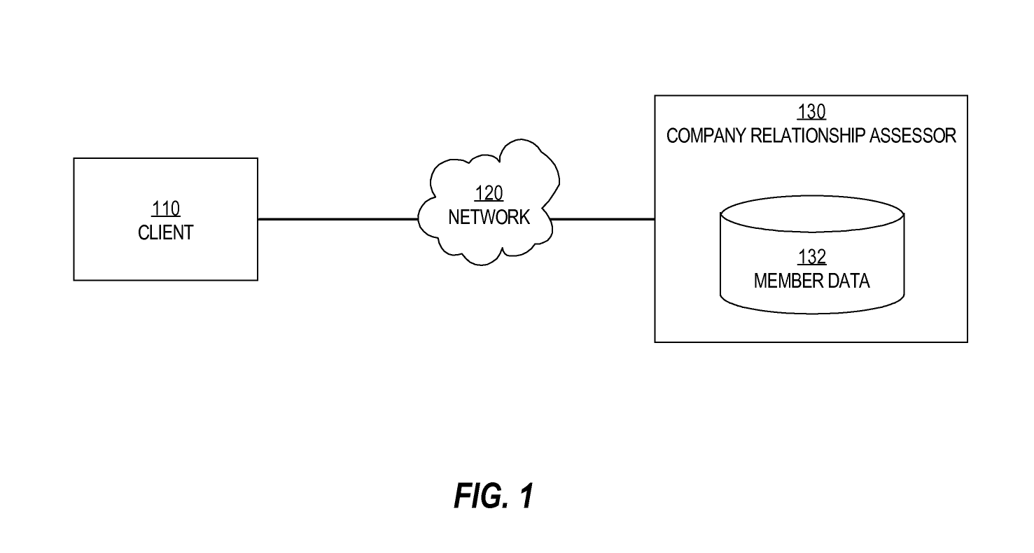

FIG. 1 is a block diagram that depicts an example system 100 for assessing relationships among companies, in an embodiment. System 100 includes client 110, network 120, and company relationship assessor 130. Although only a single client 110 is depicted, system 100 may include multiple clients. Also, while company relationship assessor 130 is depicted as a single element, company relationship assessor 130 may be implemented on multiple computing devices, some of which are interconnected in a local network and some of which may be distributed globally.

Client 110 is a computing device that is configured to transmit an address book, such as email addresses, to company relationship assessor 130 over network 120. Examples of client 110 include a laptop computer, a tablet computer, a desktop computer, and a smartphone. Although client 110 is depicted as being located remotely from company relationship assessor 130, client 110 may be located on the same network as company relationship assessor 130.

Network 120 may be implemented on any medium or mechanism that provides for the exchange of data between client 110 and company relationship assessor 130. Examples of network 120 include, without limitation, a network such as a Local Area Network (LAN), Wide Area Network (WAN), Ethernet or the Internet, or one or more terrestrial, satellite or wireless links.

In an embodiment, company relationship assessor 130 is provided by a social network provider, examples of which include LinkedIn, Facebook, and Google+. The social network provider may provide multiple services, such as services that enable members to connect with each other, to invite non-members to join a social network, to send private messages to each other, to post public messages available for all connections to view, to view profiles of first degree connections (and, optionally, second degree connections), to search for members (whether connected to them or not) based on one or more search criteria, etc.

Company relationship assessor 130 stores (or has access to) member data 132 about multiple users (or “members”) who have registered with a social network provider. Member data 132 includes user profile information for each member and connection information for each member. Thus, member data 132 indicates, for one member, a list of other members to which that member is connected in a social graph. A user profile for a member may include information provided by the member, provided by other members, and/or generated based on an analysis of the member's activity or interaction with the social network provider and/or with one or more third party services. For example, a member may include, in his/her profile, job history data that indicates organizations at which the member previously worked or was otherwise affiliated. The job history data may specify a company name, a job title or role, a description of the member's duties while at the organization, and a time range during which the member worked at the organization.

Company relationship assessor 130 may also store (or have access to) company mapping data that maps company names to company identifiers (IDs). If a member's user profile includes a company name, then the user profile may be supplemented to include a company ID, which may or may not be visible to end-users.

### Process Overview

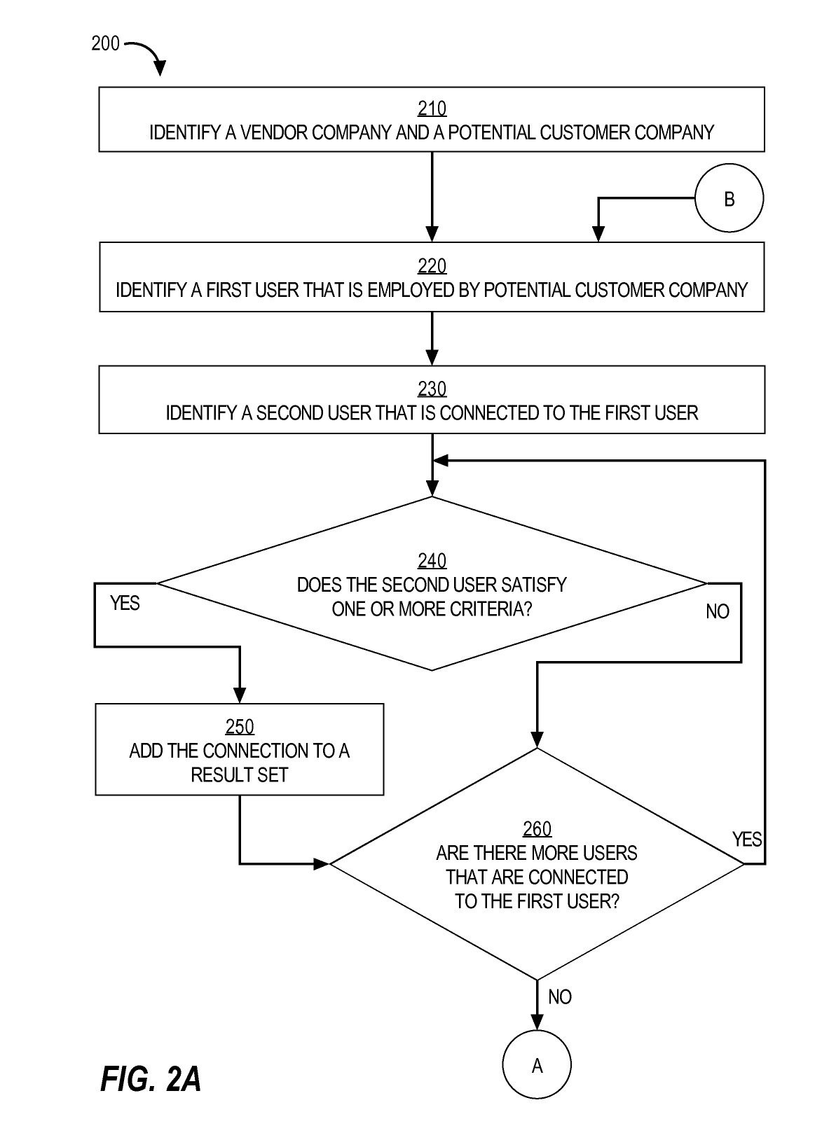

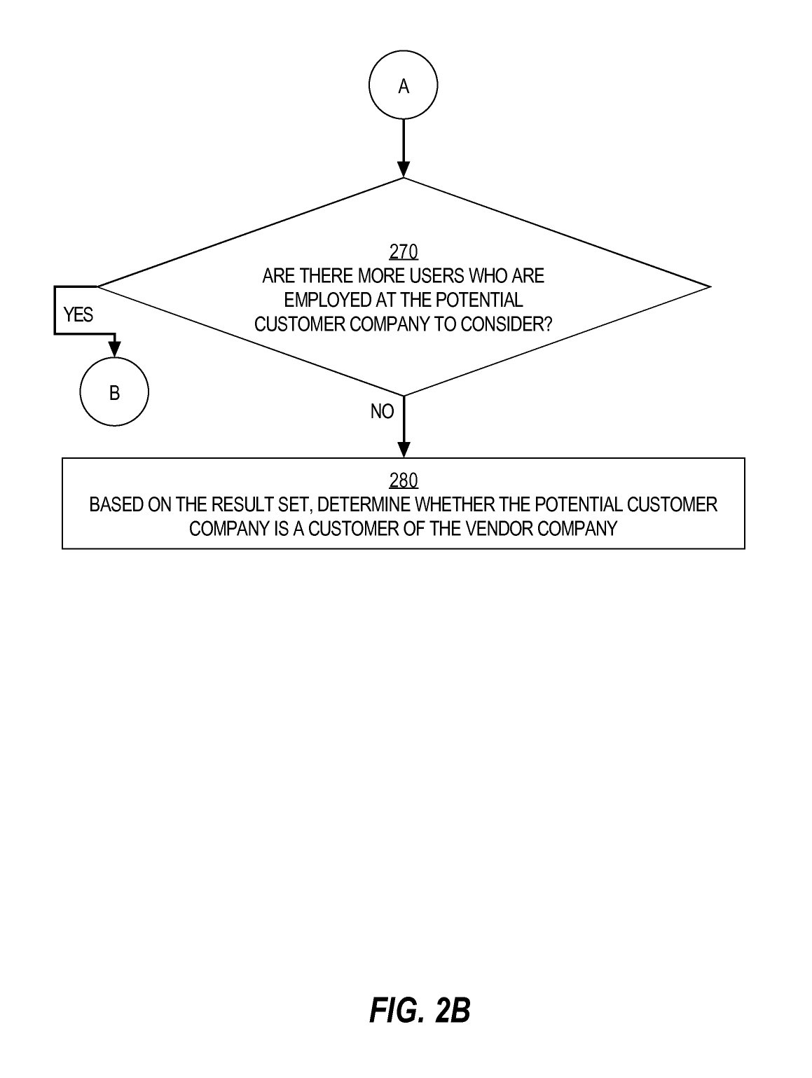

FIG. 2A-2B are flow diagrams that depict a process 200 for assessing a relationship between two companies, in an embodiment. Process 200 may be performed by company relationship assessor 130.

At block 210, two companies are identified. Block 210 may involve receiving, from client 110, input that identifies the two companies: a vendor company and a potential customer company. Alternatively, the input may identify a potential customer company and multiple vendor companies. In that embodiment, blocks 220-280 may be repeated for each identified vendor company.

The input may comprise text or voice input that is converted into text. Thus, block 210 may also involve looking up, for each specified company name, a company identifier (ID) that uniquely identifies the company relative to other companies indicated in member data 132.

At block 220, a first user that is employed by (or indicates in her user profile that she is employed by) the potential customer company is identified in a social network. Block 220 may involve determining that the first user is associated with a particular role or job function at the potential customer company.

At block 230, a second user that is connected to the first user is identified. Block 230 may involve identifying, in a user profile of the first user, a list of connections of the first user. During the first iteration of block 230, the second user may be the first connection in the list.

At block 240, it is determined whether the second user satisfies one or more criteria. Example criteria include being employed by the vendor company and being associated with a particular role or job function at the vendor company. If the second user satisfies the one or more criteria, then process 200 proceeds to block 250; else, process 200 proceeds to block 260.

At block 250, connection data that identifies the connection between the first user and the second user is added to a result set, which is initially empty when block 210 is first performed for a vendor-potential customer pair.

At block 260, it is determined whether there are more users that are connected to the first user (identified in the most recent iteration of block 220). If so, process 200 returns to block 240, where another connection of the first user is selected. Else, process 200 proceeds to block 270.

At block 270, it is determined whether there are more users who are employed at the potential customer company to consider. If so, process 200 returns to block 220 where another user that is affiliated with (or is employed by) the potential customer company is selected. Else, process 200 proceeds to block 280.

At block 280, based on the result set added to in block 250, it is determined how likely it is that the potential customer company is a customer of the vendor company. Block 280 may additionally involve generating and sending, to client 110, a score to be displayed on a screen of client 110. The score may indicate a binary “likely/not likely” result or a specific value in a range of values (e.g., 93%) indicating the likelihood that the potential customer company is a customer of the vendor company. If no connection exists between users at the potential customer company and users at the vendor company or no connection that satisfies certain criteria exists, then a likelihood score may be 0.

Additionally or alternatively, block 280 may involve sending, to client 110, connection data that indicates a number of users at the potential customer company who have a particular type of relationship with users at the vendor company. With more comprehensive information, a viewer of the connection data may make a more informed decision on whether the viewer's company should spend resources attempting to persuade the potential customer company to become an actual customer of the viewer's company.

In the embodiments described previously, the input in block 210 specifies one or more vendor companies. In a related embodiment, the input in block 210 specifies (or indicates) a single potential customer company and a type of vendor company or industry, such as IT services, retail marketing services, car parts distribution, and trucking services. The type of vendor company may be selected from a dropdown menu that is displayed on client 110 or may be specified using text or voice input. In response to receiving the vendor company type, company relationship assessor 130 determines whether any workers at the potential customer company are connected to any workers at a company that is classified as being of the vendor company type.

In a related embodiment, the input in block 210 specifies a single potential customer company and company relationship assessor 130 then identifies one or more possible vendors of the potential customer company based solely on social connections between people who work at the potential customer company and people who work at other companies. Because the number of such connections may be very large, the social connections may be filtered by one or more criteria, such as only considering (a) connections that were made in the last year, (b) people who are associated with certain job titles or job functions at the potential vendor companies, and/or (b) connections where the both users do not have a common school and common employer.

### Relevant Job Functions

Mere existence of a connection between users who worked at different companies may not mean that one company is a customer of the other company. For example, two users may be connected to each other because they have attended the same undergraduate institution or the same high school, worked at the same prior company, or met at the same religious or civic organization. Also, people who work in a HR (human resource) department tend to be connected to a lot of people. Therefore, in an embodiment, the job titles of the respective users are considered when determining whether one company is a customer of another company. For example, the fact that an HR person at a potential customer company is connected to a product manager at a vendor company does not necessarily mean that the potential customer company is an actual customer of the vendor company. In fact, if there are no other connections between workers of the respective companies, then there is very little chance that there is a vendor-customer relationship.

In an embodiment, relevant job functions are defined such that company relationship assessor 130 searches for users who not only work at a potential customer company, but also who have one of the pre-defined job functions (or a job title that maps to a pre-defined job function). Similarly, relevant job functions may be defined for users who work at a vendor company and who have one of a pre-defined set of job functions.

Examples of pre-defined job functions that indicate a pre-sales relationship include Account Executive and Sales Development Representative. Examples of pre-defined job functions that indicate a post-sales relationship include Customer Success Manager, Customer Support Manager, Program Manager, Implementation Consultant, and Trainer.

In a related embodiment, job functions are not pre-defined. For example, with reference to FIG. 1, client 110 may send input that not only specifies a potential customer company and a vendor company, but also a set of one or more job functions associated with the potential customer company and/or a set of one or more job functions associated with the vendor company. Company relationship assessor 130 will use the input as search criteria to identify the appropriate users who are associated with a job function in the set. If the input from client 110 does not specify a set of one or more job functions for either of the potential customer company or the vendor company, then a pre-defined set of one or more job functions may be used to perform the analysis of process 200.

Some members of a social network may provide a job title instead of a job function. Thus, in an embodiment, company relationship assessor 130 stores (or have access to) title-function mapping data that maps job titles to job functions. Some job titles may map to more than one job function and some job functions may map to more than one job title. In an alternative embodiment, company relationship assessor 130, when determining a type of relationship between two companies, job titles of connected users are considered instead of job function.

### Stages of a Sale Process

Connections between users of different companies having certain job titles/functions may indicate certain types of relationships between the different companies. For example, two connected users having particular job functions may indicate that one company is likely a customer of the other company. As another example, two connected users having particular job functions may indicate that one company is at least being pursued by the other company to be a customer of the other company.

Different sets of job functions may indicate different stages of a sale process: such as a pre-sales stage, a post-sales stage, and partnership stage. One or more of these stages may be further refined into sub-stages. A sub-stage may be determined not just by respective job functions of two users who are connected, but also by the number of connections with the appropriate set of job functions. For example, if there are more than three user connections that indicate a pre-sales stage between a vendor and a potential customer company and there are no connections that indicate a post-sales stage, then it may be determined that the relationship between the two companies has advanced to a final sub-stage within the pre-sales stage.

A connection (between a first company and a second company) that indicates that the first company and the second company have a pre-sales relationship is referred to herein as “pre-sales connection.” Similarly, a connection (between a first company and a second company) that indicates that the first company and the second company have a post-sales relationship is referred to herein as “post-sales connection.”

In an embodiment, a pre-defined set of job functions that are relevant to a vendor company and a potential customer company varies depending on the type of connection (e.g., pre-sales connection of post-sales connection) and the product or service that the vendor company is selling. For example, a vendor company in the Information Technology industry would want to sell products and services to IT job functions in the potential customer company; a vendor company in the Financial Services industry would want to sell products and services to finance professionals in the potential customer company; and a vendor company in the Marketing & Advertising industry would want to sell products and services to marketers in the potential customer company.

The job title (indicated in an online profile) of an employee may not be indicative of all the job functions that the employee may have, especially for smaller companies. Therefore, in an embodiment, a first job title-to-job function mapping is used for employees of relatively larger (e.g., greater than one hundred employees) and/or established companies (e.g., greater than three years old) and a second title-to-function mapping is used for employees of relatively smaller and/or newer companies. For at least some job titles in the second title-to-function mapping, the job titles may map to more job functions than equivalent job titles in the first title-to-function mapping.

### Relationships Report

Company relationship assessor 130 generates a report for a user (e.g., operating client 110) or organization that initiated the report. Table A is an example report that lists vendors (Company A through Company C) for a single potential customer, Company X.

TABLE A

| | Pre- | Post- | | | Is Company X |
|---|---|---|---|---|---|
| | Sales | Sales | Partnership | Other | a Customer? |
| Company A | 24 | 2 | 3 | 8 | Y |
| Company B | 2 | 2 | 1 | 1 | Y |
| Company C | 5 | 0 | 0 | 5 | N |

Because there are multiple post-sales connections (i.e., two) between Company A and Company X and between Company B and Company X, company relationship assessor 130 determines that Company X is a customer of Company A and Company B. Conversely, because there are no post-sales connections between Company C and Company X, company relationship assessor 130 determines that Company X is not a customer of Company C.

Table B is an example report that lists the same vendors as Table A (Company A through Company C), but the report is for another potential customer, Company Y.

TABLE B

| | Pre- | Post- | | | Is Company Y |
|---|---|---|---|---|---|
| | Sales | Sales | Partnership | Other | a Customer? |
| Company A | 10 | 0 | 2 | 1 | N |
| Company B | 2 | 0 | 0 | 0 | N |
| Company C | 1 | 1 | 0 | 1 | Y |

In this example, there are no post-sales connections between Company A and Company Y and between Company B and Company Y. Therefore, company relationship assessor 130 determines that Company Y is not a customer of either Company A or Company B. However, there is a single post-sales connection between Company C and Company Y; thus, company relationship assessor 130 determines (at least in this example) that Company Y is a customer of Company C.

However, in some embodiments, a single post-sale relationship alone is not enough to make a determination that a vendor-customer relationship is likely to exist. Other factors may be taken into account in order to make a yes/no determination, such as attributes of the pre-sales and post-sales connection(s) (e.g., the age of the post-sale connection), the order in which the pre-sales connection(s) and the post-sale connection(s) were made, and attributes of the respective companies (e.g., company size, age, industry, location).

In an embodiment, instead of (or in addition to) a binary yes/no determination, company relationship assessor 130 generates a score, for example, on a 0-100 scale. The score indicates a likelihood that one company is a customer of another company. The score may be based on multiple factors, such as number of pre-sales connections, number of post-sales connections, number of partnership connections, when the different connections were made, an order in which the connections were made (e.g., post-sales connection(s) occurred after pre-sales connections), when the different connections were made in relation to each other (e.g., post-sales connection occurred within a week of the most recent pre-sales connection), geography of the respective companies, size of the two companies, and time of existence of the two companies.

For example, the further apart geographically one company (or its headquarters) is from another, the less likely the two companies have a customer-vendor relationship. This factor is used to reduce the likelihood that the two companies are in pre-sales stage relationship or in a post-sales stage relationship, even though there may be one or more pre-sale connections and/or post-sale connections between people affiliated with the respective companies. Geographic location information of companies and/or their sales teams may be retrieved from a social graph to which company relationship assessor 130 may have access or from an external source, such as a search engine (based on a search), a company web page, etc.

As another example, if one company was organized in the last four months, then it is less likely that is has a customer-vendor relationship with another company.

As another example, if all the post-sales connections were created after all the pre-sales connections, then this factor may be indicative that a vendor-customer relationship exists.

As another example, the industry of a company may increase or decrease the likelihood that two companies are in a customer-vendor relationship.

### Changes Over Time

In an embodiment, the number of connections between two companies is tracked. For example, on Day 1, the number of pre-sales connections is one. On Day 2, the number of pre-sales connections is two. On Day 3, the number of pre-sales connections is four. If the change in the number of pre-sales connections over time is greater than a threshold (e.g., going from one to four in less than a week), then such a change may indicate that the respective companies are nearing a vendor-customer relationship. In this example, the number of pre-sales connections is tracked over time. In a related example, a total number of connections (regardless of type) is tracked and reported.

In an embodiment, company relationship assessor 130 is configured to track events for certain pairs of companies. For example, a user (representing a vendor company) may subscribe for notifications regarding a change in the number of pre-sales connections between a potential customer company and one or more other vendor companies, the number of post-sales connection between the potential customer company and the one or more other vendor companies, and/or in a threshold rate of change of either of these two numbers. In this way, a vendor company may stay apprised of whether potential (or existing) customers are currently being targeted by competing vendor companies.

In some cases, no pre-sales and post-sales connections are made between people affiliated with a vendor company and people affiliated with a potential customer company after a period of time, such as the last year. The absence of new connections may indicate that the potential customer company is not (or is no longer) a customer of the vendor company. Another vendor company may choose to invest resources into marketing to the potential customer company. Therefore, in an embodiment, company relationship assessor 130 (or another component of a social network provider) determines a time since any relationship (or a certain type of relationship) was created between two companies. If the period of time is greater than a particular threshold, then company relationship assessor 130 creates and stores a record that may be (a) retrieved by another (interested) vendor company or (b) automatically sent to the other vendor company that subscribed to such alerts.

### Analyzing Known Relationships

In an embodiment, online content is analyzed to determine whether one company is a customer of another company. For example, a website provided by Company A might list Company B as a customer. As another example, an online news article indicates that Company C recently purchased 1,000 widgets from Company D. The process of analyzing online content may involve a web crawler crawling (or identifying) web pages that are linked to each other and searching for certain content, such as certain phrases or keywords within web pages or web pages that have certain titles (e.g., “Customer Page”).

After a list of known pairs of customers and vendors, a social graph is analyzed to identify connections between pairs of users who work at the respective companies. The respective job functions (or titles) associated with each connection are analyzed to determine whether the connection indicates a pre-sale stage or a post-sale stage relationship between the companies. A result of the analysis may indicate, for each known vendor-customer relationship, a number of pre-sales connections and a number of post-sales connections.

The result of each customer-vendor pair may be aggregated based on one or more criteria, such as company size (of one or both of the companies), company geography, industry (e.g., software technology, textiles, retail, entertainment), market capitalization, number of years since formed, a level of popularity, etc. In this way, patterns in the number of pre-sales and post-sales connection in certain types of customer-vendor relationships may appear. For example, companies that have more than 1,000 employees may tend to have at least five pre-sales connections and over ten post-sales connections. As another example, retail companies in southern states may tend to have three pre-sales connections and less than eight post-sales connections.

### Model Generation

Information about known vendor-customer relationships and, optionally, known non-vendor-customer relationships is used to train a statistical model to learn the attributes of connections and/or companies that are indicative of a vendor-customer relationship. Any type of statistical model may be used. Embodiments are not limited to any particular type.

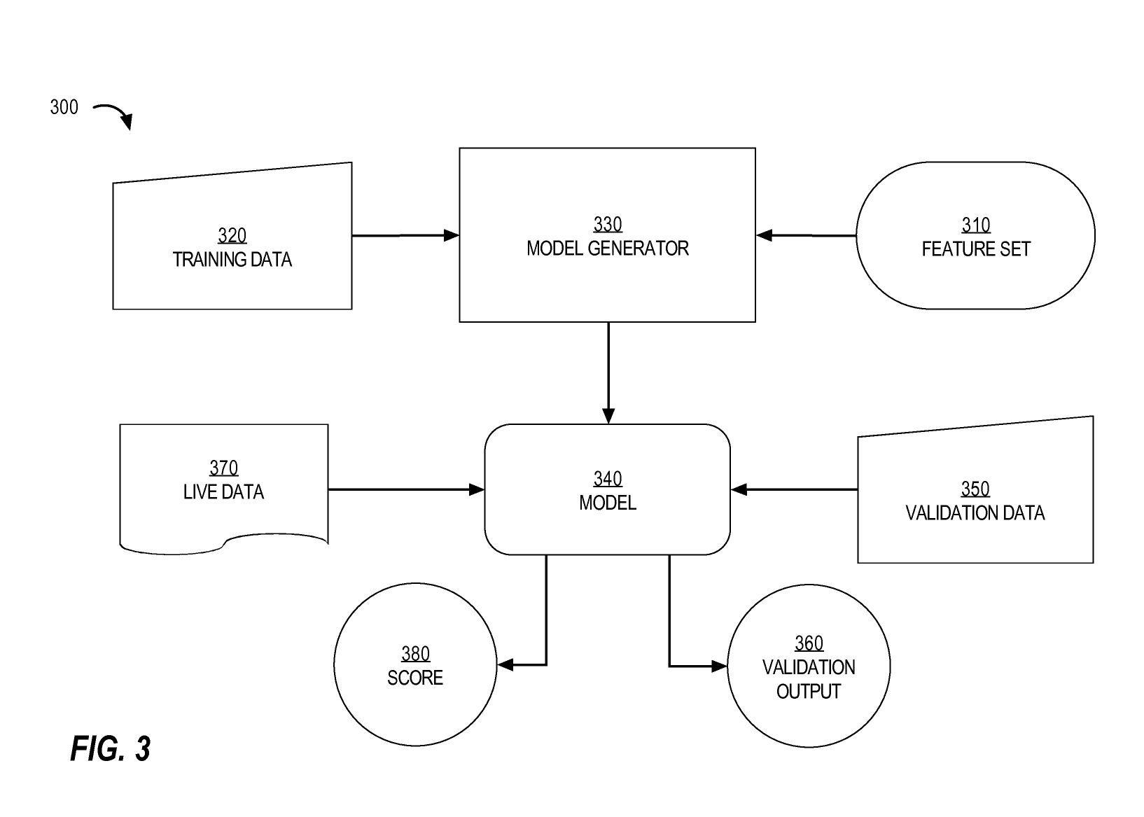

FIG. 3 is a block diagram that depicts a process 300 for generating, training, and using a model for determining a likelihood that one company is a customer of another company, in an embodiment. Process 300 may be implemented in hardware, software, or a combination of hardware and software.

Feature set 310 is provided as input to model generator 330. Feature set 310 may be specified by one or more users. Features in feature set 310 may be based on attributes of relevant connections, such as the duration of a connection (e.g., five years), number of pre-sales connection, number of post-sales connections, number of common user attributes, whether the users of a connection attended the same school at the same time in the past, whether the users of a connection worked at the same entity at the same time in the past, current residence information of the users of each connection, and the time of year the connections were made. Features in feature set 310 may also be based on attributes of the two companies, such as size of each company, the difference in size between the two companies, how long each company has been organized, geographic location of the main headquarters of each company, geographic location of the certain teams (e.g., sales team) of each company (if known), industry of each company, etc.

Training data 320 is provided as input to model generator 330. Training data 320 comprises multiple data sets, each data set corresponding to a different vendor-customer pair. Some of data sets are labeled as an “actual” vendor-customer pair while other data sets may be labeled as non-vendor-customer pairs, if such non-vendor-customer pairs are known, which may be difficult to verify. The data sets in training data 320 may have been gathered over a long period of time or may be restricted to only vendor-customer pairs that have been established relatively recently, such as within the last two years.

Model generator 330 analyzes training data 320 based on the features indicated in feature set 310. Output of model generator 330 is model 340.

Before using model 340 for making vendor-customer relationship determinations, model 340 is validated based on validation data 350, which includes multiple data sets. However, the number of data sets in validation data 350 may be much less (e.g., three times less) than the number of data sets in training data 320. Model 340 generates validation output 360 that indicates a score for each data set in validation data 350.

Although FIG. 3 depicts model 340 has receiving validation data 350 and live data 370, a different version of model 340 may receive and process live data 370 than the version that received and processed validation data 350. Thus, an analysis of validation output 360 may indicate that model 340 is not ready for production or for use in making reliable vendor-customer relationship determinations. Therefore, model generator 330 or another component (not depicted) may refine or further modify model 340.

A score threshold may be selected after model 340 is validated based on analyzing validation output 360. A score threshold is selected such that the false positive rate is below a first threshold (e.g., 1%) and the true positive rate is above a second threshold (e.g., 70%). Once an acceptable score threshold is selected, live data 370 is provided as input to model 340, which produces score 380.

### Company Relationship Assessment as a Service

In an embodiment, company relationship assessor 130 is utilized by multiple third parties to determine, for each third party, whether to market to certain potential customers. For example, an IT services company interacts with company relationship assessor 130 to determine whether a particular software company has an existing relationship with another IT services company. Later, a marketing company interacts with company relationship assessor 130 to determine whether one or more clothes retailers has a post-sales stage relationship with another marketing company.

As a specific example, a third-party user (e.g., someone representing a particular company) operating client 110 sends, to company relationship assessor 130, a list of potential customer companies. In response, company relationship assessor 130 identifies, for each potential customer company identified in the list, a set of likely (or possible) vendors. The set of vendors may include one or more values for each vendor. The values may be likelihoods that the vendors have a post-sale relationship, pre-sale, or no pre-sale relationship with a potential customer company. Additionally or alternatively, the values may include a number of pre-sales connections, post-sales connections, partnership connections, and/or “other” connections.

As another example, a user operating client 110 sends, to company relationship assessor 130, a list of competitors (i.e., other vendors) of a particular vendor. In response, company relationship assessor 130 identifies, for each competing vendor identified in the list, a set of likely customers of the competing vendor and/or a set of potential customers of the competing vendor.

### Identifying Likely Customers

Some of the approaches described above are used to determine whether a potential customer company is already a customer of one or more vendors. The result of the determination is a factor in determining whether a vendor company should market to the potential customer company.

Other factors may be used to determine whether a vendor company should market to a potential customer company, regardless of whether the potential customer company is a likely customer of one or more competing vendor companies. In other words, even though a potential customer company is not likely a customer of any competing vendor company, a particular vendor company may choose to not market to the potential customer company based on one or more other factors.

Such factors may be used to generate a match score that reflects a likelihood of success or the strength of a match that the potential customer company may be to the vendor company. Such a match score may be generated and provided along with the “relationship” score described previously. Additionally or alternatively, the match score may be incorporated into the relationship score. Examples of such factors include the similarity between (a) the type of product or service that the vendor company sells and (b) usage data or profile data indicating usage of a product/service by employees of a potential customer company.

For example, a vendor company that sells Microsoft-based IT software to companies may be more likely be successful in selling to customer companies that already use Microsoft products, compared to companies which use alternative products, such as Google products or open-source products.

The brand of products being used by a company may be determined in one of multiple ways, including browsing data and profile data. As an example, the types of web browsers that social network users are using when they visit a social network provider are detected. For each social network user, it is determined which web browser (e.g., Microsoft Internet Explorer, Google Chrome, or Mozilla Firefox) the particular user is using to connect with the social network provider. Also, each social network user indicates his/her employer in their respective profile. Thus, browsing data of employees of a particular company is aggregated to determine which brand of browser the employees use, which can infer whether the company is more likely to favor using a particular web browser as a corporate standard. Furthermore, if it is determined that the IP addresses that the employees are using are classified as being associated with the particular company, then it is more likely that the employees are using company devices. Such browsing data may be used to fine-tune the model for vendor companies that sell products and services specifically for companies favoring a certain brand products or, conversely, companies specifically disfavoring that brand of products.

As noted previous, in addition to browsing data, profile data associated with a company (e.g., on a social networking website) is analyzed to determine whether the company favors or disfavors specific products or services. Profile data associated with a company may include user profiles of employees of the company (e.g., job descriptions provided by the employees), an official company profile provided by the company, and job listings provided by the company. For example, a database administrator may include, in his/her profile, information about Teradata databases and not include any information about Oracle databases.

Another factor that may be considered in determining a match score is past success of a vendor company. For example, a vendor company may sell general sales/marketing technology software that can be applied to customer companies in multiple industries. However, the vendor company appears to have success in selling specifically to customers in, for example the finance industry. Thus, vendor companies may favor and find success in certain industries because of their past successes and track history.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

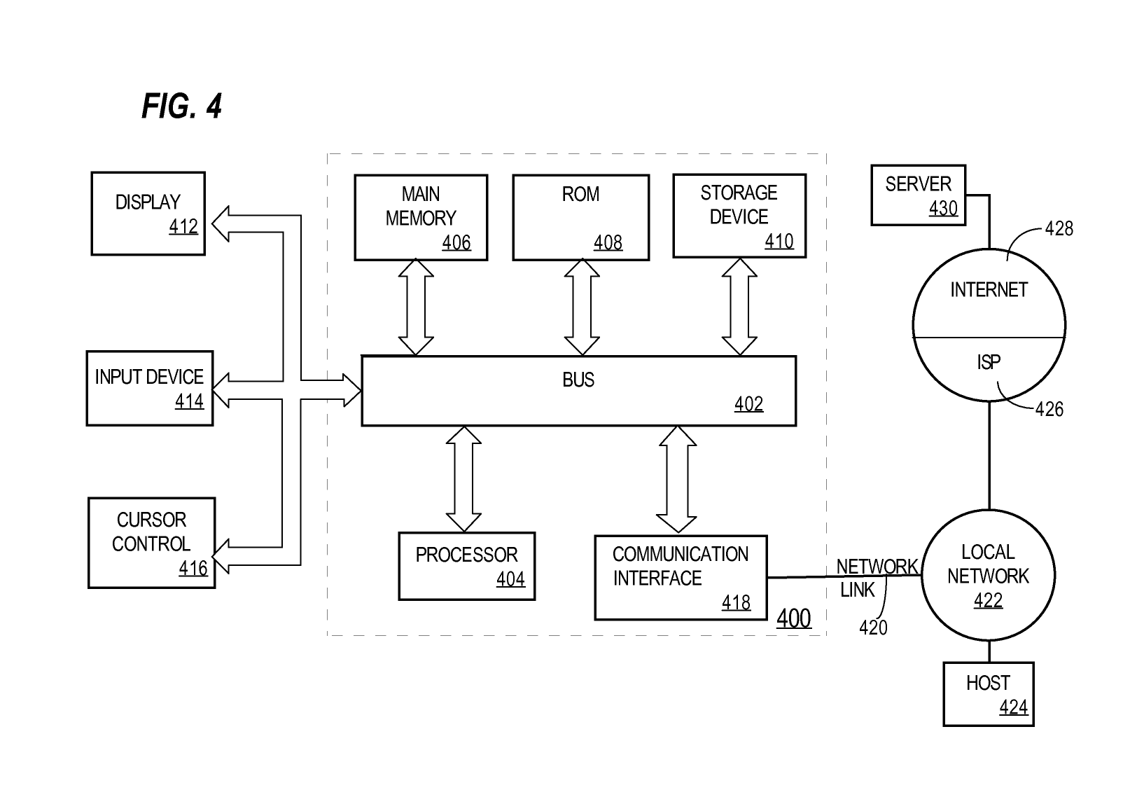

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a first user, of a social network, that is associated with a first job function at a first entity;
identifying a second user, of the social network, that is connected to the first user through the social network and that is associated with a second job function at a second entity that is different than the first entity;
identifying the second entity as a potential customer of the first entity based on a connection between the first user and the second user, the first job function, and the second job function;
wherein the method is performed by one or more computing devices.

2. The method of claim 1, further comprising:
receiving input that indicates the first entity and the second entity;
wherein identifying the first user comprises identifying the first user in response to receiving the input;
wherein identifying the second user comprises identifying the second user in response to receiving the input.

3. The method of claim 2, wherein:
identifying the first user comprises identifying a first plurality of users that includes the first user and that are associated with one or more job functions at the first entity;
identifying the second user comprises identifying a second plurality of users that includes the second user and that are associated with one or more job functions at the second entity;
the method further comprising, for each user of the first plurality of users, determining whether said each user is connected, in the social network, to a user in the second plurality of users.

4. The method of claim 1, further comprising:
receiving input that indicates one or more first job functions or job titles;
wherein identifying the second entity as a potential customer comprises identifying the second entity as a potential customer of the first entity based on a first determination that the first job function matches one of the one or more first job functions or job titles.

5. The method of claim 4, further comprising:
receiving second input that indicates one or more second job functions or job titles;
wherein identifying the second entity as a potential customer comprises identifying the second entity as a potential customer of the first entity based on a second determination that the second job function matches one of the one or more second job functions or job titles.

6. The method of claim 1, further comprising:
identifying a third user, of the social network, that is connected, through the social network, to a fourth user and that is associated with a third job function at the first entity;
wherein the fourth user is associated with a fourth job function at the second entity;
wherein identifying the second entity comprises identifying the second entity as a potential customer of the first entity based on a second connection between the fourth user and the third user, the third job function, and the fourth job function.

7. The method of claim 1, further comprising:
determining a number on connections between (a) a first plurality of users of a first plurality of entities that includes the first entity and (b) a second plurality of users that are associated with one or more job functions at the second entity;
based on the number of connections, determining a targeting score that indicates a measure of how much the second entity is being targeted as a potential customer by the first plurality of users.

8. The method of claim 1, further comprising:
determining when the first user became connected to the second user in a social graph;
wherein identifying the second entity as a potential customer of the first entity comprises identifying the second entity based on when the first user became connected to the second user in the social graph.

9. The method of claim 1, further comprising:
identifying first profile data associated with the first user;
identifying second profile data associated with the second user;
comparing the first profile data with the second profile data to determine whether one or more first data items in the first profile data match one or more second data items in the second profile data;
wherein identifying the second entity as a potential customer of the first entity comprises wherein identifying the second entity as a potential customer of the first entity based on an existence of a match between the one or more first data items in the first profile data with the one or more second data items in the second profile data.

10. The method of claim 9, wherein:
comparing comprises determining, based on the first profile data and the second profile data, whether the first user and the second user worked at a particular company or attended a particular academic institution at a particular point in time.

11. A method comprising:
identifying a first user, of a social network, that is associated with a first job function at a first entity;
identifying a second user, of the social network, that is connected to the first user through the social network and that is associated with a second job function at a second entity that is different than the first entity;
determining, based on a connection between the first user and the second user in the social network, the first job function, and the second job function, that the first entity and the second entity are in a vendor-customer relationship;
wherein the method is performed by one or more computing devices.

12. A method comprising:
receiving input that identifies a first company and a second company;
in response to receiving the input:
identifying, in a social network, a first plurality of users that are associated with the first company;
for each user of the first plurality of users:
determining whether said each user is connected, in the social network, to another user that is associated with the second company;
if it is determined that said each user is connected to another user that is associated with the second company, then adding connection data to a result set, wherein the connection data indicates one or more attributes of the connection;
based on the result set, generating a score the reflects a likelihood that the first company is a customer of the second company;
wherein the method is performed by one or more computing devices.

13. A system comprising:
one or more processors;
one or more storage media storing instructions which, when executed by the one or more processors, cause:
identifying a first user, of a social network, that is associated with a first job function at a first entity;
identifying a second user, of the social network, that is connected to the first user through the social network and that is associated with a second job function at a second entity that is different than the first entity;
identifying the second entity as a potential customer of the first entity based on a connection between the first user and the second user, the first job function, and the second job function.

14. The system of claim 13, wherein the instructions, when executed by the one or more processors, further cause:
receiving input that indicates the first entity and the second entity;
wherein identifying the first user comprises identifying the first user in response to receiving the input;
wherein identifying the second user comprises identifying the second user in response to receiving the input.

15. The system of claim 14, wherein:
identifying the first user comprises identifying a first plurality of users that includes the first user and that are associated with one or more job functions at the first entity;
identifying the second user comprises identifying a second plurality of users that includes the second user and that are associated with one or more job functions at the second entity;
the instructions, when executed by the one or more processors, further cause, for each user of the first plurality of users, determining whether said each user is connected, in the social network, to a user in the second plurality of users.

16. The system of claim 13, wherein the instructions, when executed by the one or more processors, further cause:
receiving input that indicates one or more first job functions or job titles;
wherein identifying the second entity as a potential customer comprises identifying the second entity as a potential customer of the first entity based on a first determination that the first job function matches one of the one or more first job functions or job titles.

17. The system of claim 16, wherein the instructions, when executed by the one or more processors, further cause:
receiving second input that indicates one or more second job functions or job titles;
wherein identifying the second entity as a potential customer comprises identifying the second entity as a potential customer of the first entity based on a second determination that the second job function matches one of the one or more second job functions or job titles.

18. The system of claim 13, wherein the instructions, when executed by the one or more processors, further cause:
identifying a third user, of the social network, that is connected, through the social network, to a fourth user and that is associated with a third job function at the first entity;
wherein the fourth user is associated with a fourth job function at the second entity;
wherein identifying the second entity comprises identifying the second entity as a potential customer of the first entity based on a second connection between the fourth user and the third user, the third job function, and the fourth job function.

19. The system of claim 13, wherein the instructions, when executed by the one or more processors, further cause:
determining a number on connections between (a) a first plurality of users of a first plurality of entities that includes the first entity and (b) a second plurality of users that are associated with one or more job functions at the second entity;
based on the number of connections, determining a targeting score that indicates a measure of how much the second entity is being targeted as a potential customer by the first plurality of users.

20. The system of claim 13, wherein the instructions, when executed by the one or more processors, further cause:
determining when the first user became connected to the second user in a social graph;
wherein identifying the second entity as a potential customer of the first entity comprises identifying the second entity based on when the first user became connected to the second user in the social graph.

21. The system of claim 13, wherein the instructions, when executed by the one or more processors, further cause:
identifying first profile data associated with the first user;
identifying second profile data associated with the second user;
comparing the first profile data with the second profile data to determine whether one or more first data items in the first profile data match one or more second data items in the second profile data;
wherein identifying the second entity as a potential customer of the first entity comprises wherein identifying the second entity as a potential customer of the first entity based on an existence of a match between the one or more first data items in the first profile data with the one or more second data items in the second profile data.

22. The system of claim 21, wherein:
comparing comprises determining, based on the first profile data and the second profile data, whether the first user and the second user worked at a particular company or attended a particular academic institution at a particular point in time.
